(19) United States
(12) Patent Application Publication
(10) Pub. No.: US 2010/0052354 A1
(43) Pub. Date: Mar. 4, 2010

(54) COMPOSITE STAKE RACKS FOR FLATBED TRUCK BODY

(75) Inventors: Roderick Scott MacLeod, Louisville, KY (US); Keith Ping, Danville, KY (US)

Correspondence Address: PEPPER HAMILTON LLP, ONE MELLON CENTER, 50TH FLOOR, 500 GRANT STREET, PITTSBURGH, PA, 15219, US

(73) Assignee: ABC DISTRIBUTION, LLC, Shillington, PA (US)

(21) Appl. No.: 12/522,676

(22) PCT Filed: Jan. 9, 2008
(86) PCT No.: PCT/US08/50611

§ 371 Date: Nov. 11, 2009

Related U.S. Application Data
(60) Provisional application No. 60/884,082, filed on Jan. 9, 2007.

(51) Int. Cl. B60P 7/06

(52) U.S. Cl. 296/43

(57) ABSTRACT

A panel for a stake rack assembly for a cargo area of a truck bed includes a first surface and a second surface opposing the first surface. The first and second surfaces include a plurality of openings to define generally horizontal sections and generally vertical sections that form rails and stakes of the panel, wherein the panel is formed of a polymer material.

### BACKGROUND

The present invention relates to stake rack assemblies for use with a flat bed truck body or the like, and in particular, stake rack assemblies formed from a polymer material.

One means for increasing the cargo carrying capacity of a flatbed or pickup truck, or like vehicle, includes stake and rail assemblies. The assemblies increase a height of the extending side and end walls of a truck bed, or provide side and end walls for a flatbed truck where none are present. Oftentimes, the truck bed includes slots or cavities formed in the sidewalls or truck bed for receiving stake members of the assemblies. The rails are attached to the stakes and extend horizontally between adjacent stakes. Typically, the assemblies are formed of steel, which are heavy, expensive to manufacture, and have a limited duration due to rusting.

### SUMMARY

In one embodiment, the invention provides a panel for a stake rack assembly for a truck bed. The panel comprises a first surface and a second surface opposing the first surface. The first and second surfaces include a plurality of openings to define generally horizontal sections and generally vertical sections that form rails and stakes of the panel, wherein the panel is formed of a polymer material.

In another embodiment, the invention provides a stake rack assembly for a cargo area of a truck bed. The stake rack assembly comprises a plurality of panels. Each panel includes an upper edge, a lower edge, and first and second side edges extending between the upper and lower edges. At least one tab extends outward from each of the side edges of each panel, wherein the at least one tab is configured for removably coupling to the at least one tab extending from an adjacent panel.

In another embodiment, the invention provides a panel for a stake rack assembly for a cargo area of a truck bed. The panel comprises an upper edge, a lower edge, and first and second side edges extending between the upper and lower edges. The panel further comprises a hinge extending from one of the side edges, wherein the panel is formed of a polymer material.

In another embodiment, the invention provides a stake rack assembly for a cargo area of a truck bed. The stake rack assembly comprises a plurality of panels. Each panel includes first and second side edges. At least one tab extends outward from the side edges of a first set of the plurality of panels such that the tab extending from each side edge of the first set of the plurality of panels is configured for removably coupling to the at least one tab extending from an adjacent panel of the first set. The stake rack assembly further comprises a hinge extending from one of the side edges of a second set of the plurality of panels, wherein each of the plurality of panels is formed of a polymer material.

Other aspects of the invention will become apparent by consideration of the detailed description and accompanying drawings.

### BRIEF DESCRIPTION OF THE DRAWINGS

FIGS. 1A and 1B illustrate a stake rack panel according to one embodiment of the invention.

FIG. 1C is a side view of the stake rack panel shown in FIGS. 1A and 1B.

FIG. 2 illustrates a plurality of stake rack panels from FIGS. 1A and 1B assembled together on a truck bed to form a side wall.

FIG. 3 illustrates a plurality of stake rack panels from FIGS. 1A and 1B assembled together at a corner of a truck bed and illustrating a hinged embodiment of the panel.

FIGS. 4A and 4B illustrate a stake rack panel according to one embodiment of the invention.

FIG. 4C is a side view of the stake rack panel shown in FIGS. 4A and 4B.

FIG. 4D is a section view of a support beam for the stake rack panel taken along line 4D-4D of FIG. 4B.

FIG. 5 illustrates a stake rack panel according to another embodiment of the invention.

FIG. 6 illustrates a stake rack panel according to another embodiment of the invention.

FIGS. 7A and 7B illustrate a stake rack panel according to a further embodiment of the invention.

FIGS. 8A and 8B illustrate a stake rack panel according to yet another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

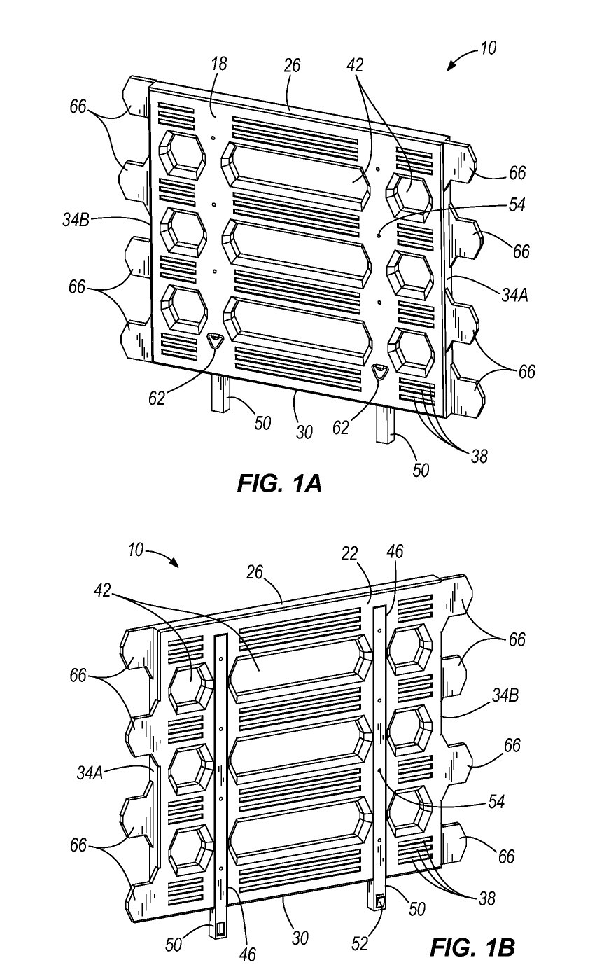

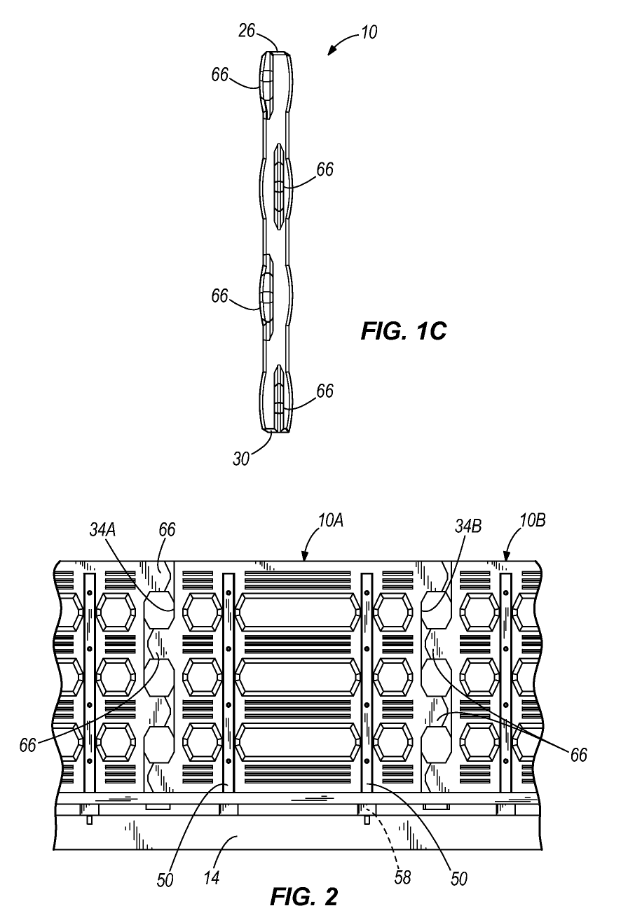

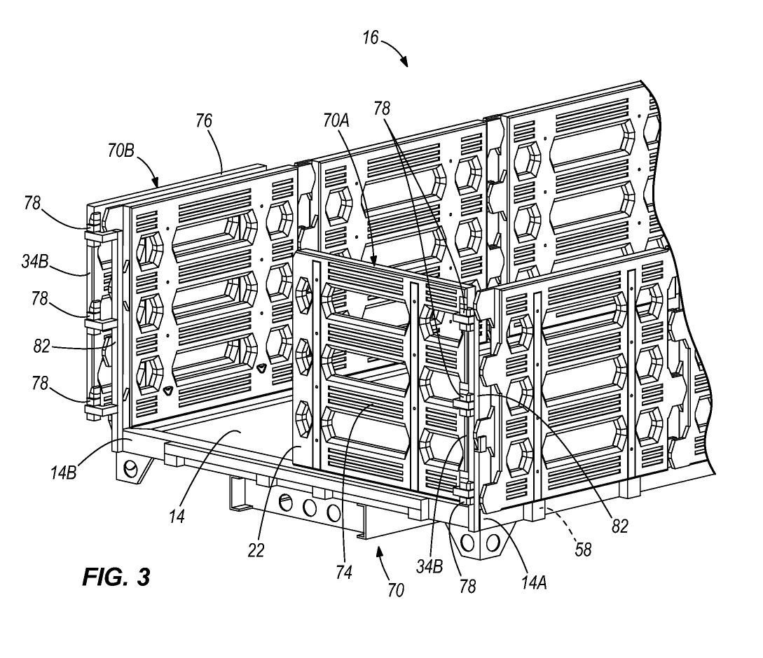

FIGS. 1A-1C illustrate a stake rack panel 10 for use with a truck bed 14 (FIGS. 2 and 3) to form a stake rack assembly 16 (FIG. 3) and increase cargo carrying capacity of the truck bed 14. The panel 10 includes generally horizontal sections and generally vertical sections to define rails and stakes of the panel 10, respectively. The panel 10 is formed of a polymer material. In one embodiment, the panel 10 is formed by rotational molding as it provides a boxed-type structure for adequate load carrying capacity. Rotational molding also allows increasing wall thicknesses to modify the strength of the structure without additional tooling cost. It should be readily apparent to those of skill in the art that other molding processes may be used to form the panel 10, such as, but not limited to, thermoformed and structural foam (injection molded) processes.

The panel 10 includes a first surface 18 and opposed second surface 22, as well as an upper edge 26, a lower edge 30 and a pair of side edges 34A, 34B extending between the upper and lower edges 26, 30. The first and second surfaces 18, 22 include ribs 38 and openings 42 to provide a relatively lightweight structure with adequate strength to the panel 10. Referring to FIG. 1B, the panel 10 includes channels 46 recessed from the second surface 22 whereby each channel 46 receives an upright beam 50, or stake. In the illustrated embodiment, each beam 50 is fastened to the panel 10 with a fastener 54, such as a bolt or the like. To couple the panel 10 to the truck bed 14, a free end of the beam 50 is received by a slot 58 (FIGS. 2 and 3) formed in the truck bed 14. The beams 50 provide strength and support for high loads carried within the cargo area, such as heavy drums (e.g., 55 gallon), pipes, or the like that shift against the panels. The beam 50 is formed of steel, although other known materials may be used to provide strength and support.

Referring to FIG. 1B, the beam 50 includes a spring latch 52 for removably coupling the beam 50 to the slot 58 formed in the truck bed 14. In the illustrated embodiment, the spring latch 52 is a generally wedge-shaped structure that is biased outward by a compression spring (not shown) within the beam 50. When inserting the panel 10 into the truck bed 14, the spring within the wedge-shaped latch 52 is automatically compressed by the truck bed 14 and then released when fully inserted into the truck bed 14 to retain the panel 10 in place with respect to the truck bed 14.

Referring to FIG. 1A, rings 62, or other known anchors, are positioned on the first surface 18 of the panel 10 for providing a tie down location and prevent unnecessary tying to the horizontal and vertical sections of the panel 10. In the illustrated embodiment, each ring 62 is coupled to the panel 10 by the fastener 54 coupling the beam 50 to the panel 10. It should be readily apparent to those of skill in the art that in further embodiments, the rings 62 may be coupled to the panel 10 at other locations and using other known fasteners.

The panel 10 includes interlocking tabs 66 extending outwardly from the side edges 34A, 34B for coupling adjacent panels 10 together. The tabs 66 are integrally formed as a single piece with the panel 10, for example by molding. In the illustrated embodiment, four tabs 66 extend from each side edge 34A, 34B of the panel 10. At the first side edge 34A, the tab 66 positioned proximate the upper edge 26 extends outward proximate the first surface 18 of the panel 10. The remaining tabs 66 of the first side edge 34A alternate between extending proximate the second surface 22 of the panel 10 and the first surface 18 of the panel 10. At the second side edge 34B, the tab 66 positioned proximate the upper edge 26 extends outward proximate the second surface 22 of the panel 10. The remaining tabs 66 of the second side edge 34B alternate between extending proximate the first surface 18 of the panel 10 and the second surface 22 of the panel 10. Therefore, tabs 66 of opposite side edges 34A, 34B of the panel 10 extend proximate opposite surfaces 18, 22.

FIGS. 2 and 3 illustrate a plurality of panels 10 positioned side-by-side and coupled to the truck bed 14, including interlocked tabs 66 of adjacent panels 10. To assemble the stake rack assembly 16, one panel 10A is coupled to the truck bed 14 by inserting the beams 50 into slots 58 formed in the truck bed 14. An adjacent panel 10B is then coupled to the truck bed 14 in the same manner whereby the tabs 66 along the second side edge 34B of the first panel 10A interlace and interlock with the tabs 66 along the first edge 34A of the second panel 10B. The assembly 16 and interlocking relationship between adjacent panels 10 extend about a perimeter of the truck bed 14. When one panel 10 is lifted relative to the adjacent panel, the tabs 66 no longer align with each other thereby allowing easy removal of the panel 10 and disassembly of the assembly 16.

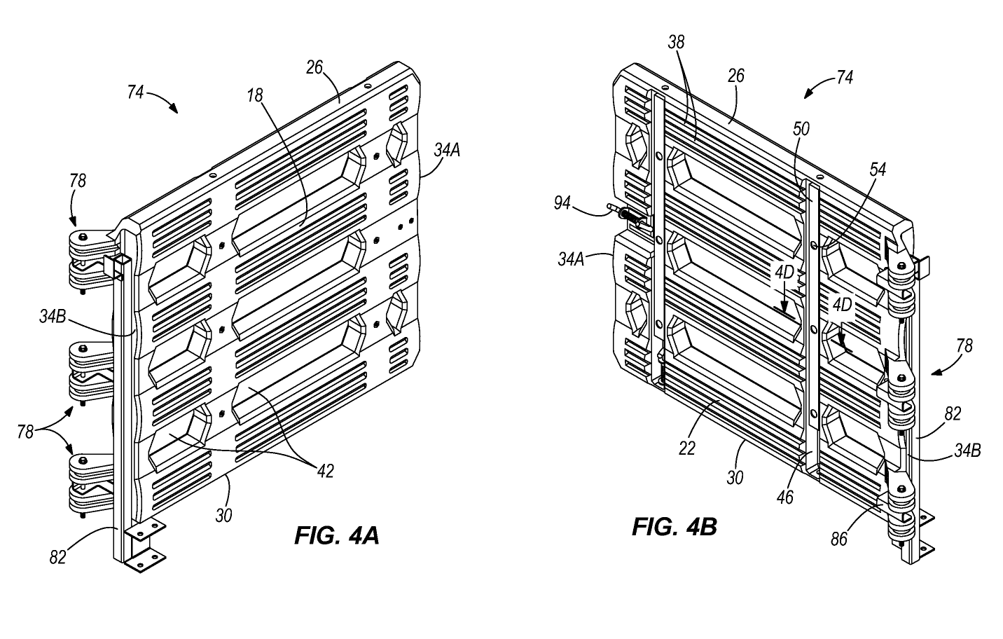

FIG. 3 illustrates a door or gate portion 70 of the stake rack assembly 16 that includes two door panels 74 pivotally coupled to the truck bed 14 such that the door panels 74 pivot between an open position and a closed position. FIGS. 4A-4D illustrate one embodiment of the door panel 74. The door panels 74 are similar to the stake rack panels 10 shown in FIGS. 1A and 1B; therefore, like structure will be identified by the same reference numerals. The door panel 74 shown in FIGS. 4A-4D does not include interlocking tabs; however, the door panel 74 does include integrally formed hinges 78 to provide a pivotal connection between the panels 74 and the truck bed 14.

The door panel 74 in FIG. 3 includes three hinges 78 formed in the second surface 22 of the panel 74 proximate one of the second side edges. The door panel 74 in FIGS. 4A-4D similarly includes three hinges 78 formed in the second surface 22 proximate the second side edge 34B. In a further embodiment, the three hinges 78 are formed in the first surface 18 of the panel 74 proximate the opposite side edge and are generally aligned with the hinges 78 in the second surface 22. It should be readily apparent to those of skill in the art that in further embodiments fewer or more hinges 78 may be formed, and the hinges 78 may be formed in the first surface 18 and/or proximate the first side edge 34A.

Referring to FIG. 3, the door panel 74 is positioned adjacent a first edge 14A of the truck bed 14 to form a first door portion 70A (i.e., the right-side of the door portion 70). In addition, another door panel 76 is positioned adjacent a second edge 14B of the truck bed 14 to form a second door portion 70B (i.e., the left-side of the door portion 70). For example, the panel 76 positioned adjacent the second edge 14B includes hinges proximate the first side edge 34A, rather than the second side edge 34B, or the side edge opposite the hinge placement of the panel 74. In a further embodiment, the door panels 74 may be positioned in one of two orientations for use on either side of the door portion 70.

Referring to FIGS. 3 and 4A-4C, a corner post 82 (e.g., a steel corner post) is pivotally coupled to the hinges 78 of the panel 74, and the corner post 82 is thereby coupled to the truck bed 14, for example by a bolt or other known fastener (FIG. 3). To open and close the door panel 74, the panel 74 pivots about the post 82 at the hinges 78.

Each hinge 78 includes a first hinge portion 78A and a second hinge portion 78B, and a bushing 86 (e.g., a nylon bushing) positioned between the two hinge portions 78A, 78B. The post 82 is coupled to the bushing 86 to pivotally couple the post 82 to the panel 74. In a further embodiment, the bushing 86 may be integrally formed with the post 82. Pins 90, or other known fasteners, pass through the hinge portions 78A, 78B and the bushing 86 to pivotally couple the bushing 86, and thereby the post 82, to the panel 74 and provide a bearing surface for pivoting of the panel 74 with respect to the truck bed. The panel 74 also includes a latch 94 for locking adjacent door portions 70A, 70B closed and to each other.

Referring to FIGS. 4B and 4D, each beam 50 is coupled to an insert 64 positioned within the channel 46 of the panel. In a further embodiment, the insert 64 may be molded into the panel. The inserts 64 provide a path entirely through the molded panel so that rings 62 may be attached directly to the fastener 54 securing the beam 50 to the panel. Therefore, the tie-down stress is thereby transferred directly to the beams 50 instead of loading through the polymer molded panel. It should be readily apparent to those of skill in the art that in further embodiments of the panel the insert 64 may be used with the support beam 50.

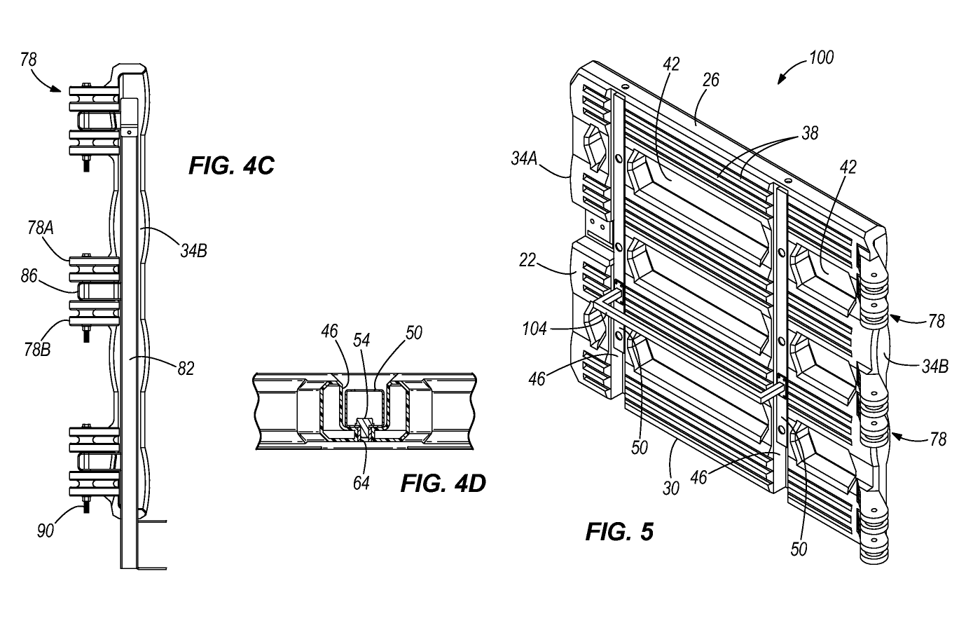

FIG. 5 illustrates one embodiment of a door panel 100 for use with the door portion 70, or swing door or gate. The door panel 100 is similar to the stake rack panels 10 shown in FIGS. 1A-1C and the door panel 74 shown in FIGS. 4A-4D; therefore, like structure will be identified by the same reference numerals. The door panel 100 shown in FIG. 5 does not include interlocking tabs, but does include integrally formed hinges 78 to provide a pivotal connection between the panel 100 and the truck bed 14.

In the illustrated embodiment, the door panel 100 includes beams 50 slidable within the channels 46 of the second surface 22 of the panel 100. A handle 104 extends between and connects the beams 50 of a single panel 100. In a lowered position, the beams 50 protrude from the lower edge 30 of the door panel 100 and are received in the slots 58 of the truck bed 14. The beams 50 hold the door panel 100 in a closed position. To pivot, or open, the door panel 100, a user lifts the handle 104 to raise the beams 50 from the slots 58, which releases the door panel 100 from the truck bed 14. In a further embodiment, the door panel 100 includes fewer or more slidable beams 50 that maintain the door panel 100 in a closed position and are raised to allow the door panel 100 to open. For example, in an embodiment including a single beam 50, a connecting handle 104 is not required to lift and lower the beam 50. Rather, a user may operate the beam 50 directly or a relatively smaller handle may be coupled to the beam 50.

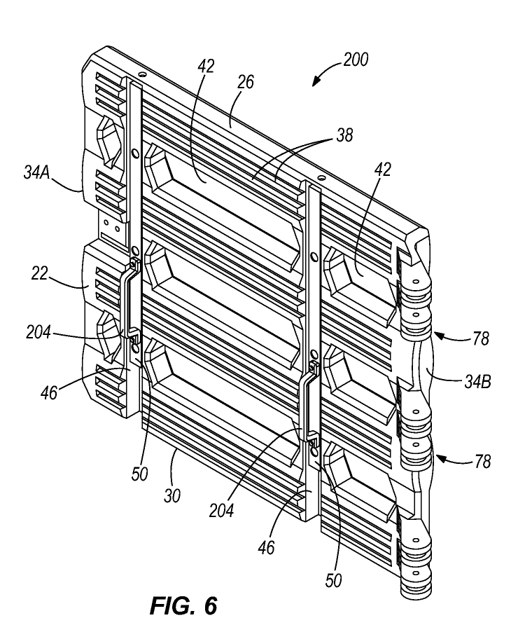

FIG. 6 illustrates another embodiment of a door panel 200. The door panel 200 is similar to the door panel 100 shown in FIG. 5; therefore, like structure will be identified by the same reference numerals. The door panel 200 shown in FIG. 6 includes a pair of handles 204 extending parallel and coupled to respective beams 50. Similar to the door 100 shown in FIG. 5, the user lifts the handles 204 to raise the beams 50 from the slots 58 to release the door panel 200 from the truck bed.

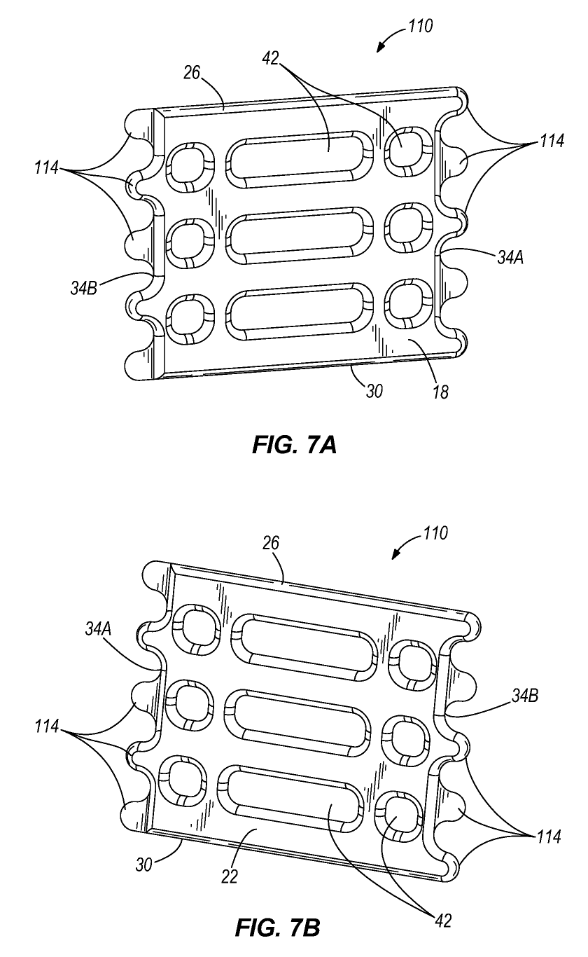

FIGS. 7A and 7B illustrate a stake rack panel 110 for use with a truck bed to form a stake rack assembly according to another embodiment of the invention. The stake rack panel 110 is similar to the panel 10 shown in FIGS. 1A-1C; therefore, like structure will be identified by the same reference numerals. The panel 110 includes generally horizontal sections and generally vertical sections to define rails and stakes of the panel 110, respectively. The panel 110 is formed of a polymer material, as described above with respect to the panel 10. In the illustrated embodiment, the panel 110 includes five interlocking tabs 114 along each side edge 34A, 34B for coupling the panel 110 to adjacent panels. Although not shown in FIGS. 4A and 4B, the panel 110 may include metal beams molded into the panel 110 for coupling the panel 110 to a truck bed.

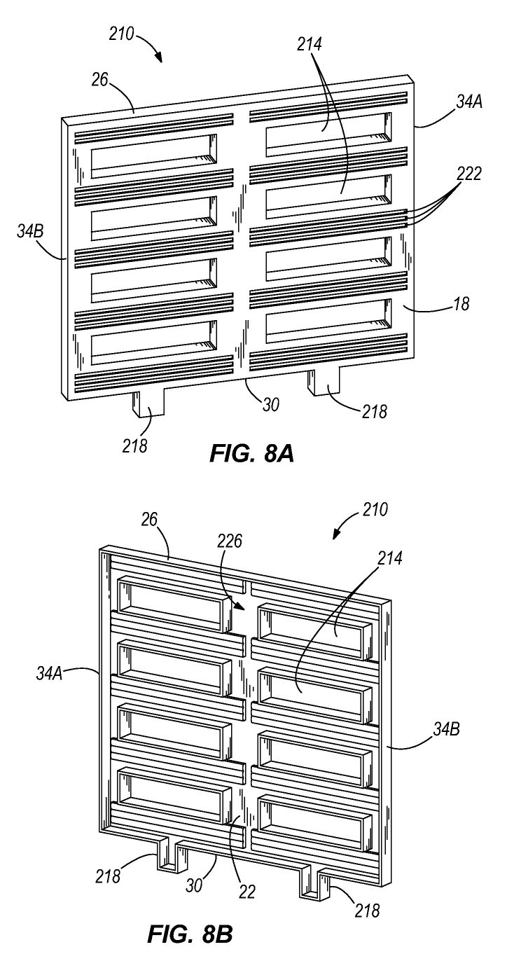

FIGS. 8A and 8B illustrate a stake rack panel 210 for use with a truck bed to form a stake rack assembly according to another embodiment of the invention. The stake rack panel 210 is similar to the panel 10 shown in FIGS. 1A-1C; therefore, like structure will be identified by the same reference numerals. The panel 210 includes openings 214 to define generally horizontal sections and generally vertical sections that form rails and stakes of the panel 210, respectively. The panel 210 is formed of a polymer material, as described above with respect to the panel 10. The panel 210 includes a first surface 18 and opposed second surface 22, as well as an upper edge 26, a lower edge 30 and a pair of side edges 34A, 34B extending between the upper and lower edges 26, 30. The lower edge 30 of the panel 210 includes projections 218 for coupling the panel 210 to a truck bed, for example, by inserting the projections 218 into slots within the truck bed. The first surface 18 includes ribs 222 to provide adequate strength to the panel 210. Referring to FIG. 8B, the second surface 22 is recessed with respect to the outer edges 26, 30, 34A, 34B of the panel 210 to define a channel 226.

A polymer panel used in a stake and rack assembly provides weight savings for the truck and reduces labor costs for manufacturing the panel. The polymer panel has an increased life span as compared to metal assemblies. The polymer material provides an improved appearance and increases color options through the molding process while reducing painting.

It is to be understood that the invention is not limited in its application to the details of the construction and the arrangements of the components set forth in the above description or illustrated in the drawings. The invention is capable of other embodiments and of being practiced or carried out in various ways which are still within the spirit and scope of the present invention. Also, it is understood that the phraseology and terminology used herein is for the purpose of description and should not be regarded as limiting.

What is claimed is:

1. A panel for a stake rack assembly for a truck bed, the panel comprising:
a first surface and a second surface opposing the first surface, the first and second surfaces including a plurality of openings to define generally horizontal sections and generally vertical sections that form rails and stakes of the panel,
wherein the panel is formed of a polymer material.

2. The panel of claim 1, and further comprising a plurality of ribs formed in the panel.

3. The panel of claim 1, and further comprising a support beam disposed in either of the first and second surfaces of the panel.

4. The panel of claim 3 wherein the support beam is formed of a metal material.

5. The panel of claim 3 wherein the support beam includes an end extending from a lower edge of the panel such that the end is operable for coupling the panel to the truck bed.

6. The panel of claim 1, and further comprising at least one tab configured for extending outward from each side edge of the panel, wherein the at least one tab extending from one of the side edges of the panel is operable for removably coupling to a corresponding tab extending from a side edge of another panel.

7. The panel of claim 1, and further comprising a ring coupled to the first surface of the panel and operable for providing a tie down location.

8. The panel of claim 1, and further comprising a hinge extending from a side edge of the panel and operable for pivotally coupling the panel to the truck bed.

9. A stake rack assembly for a cargo area of a truck bed, the stake rack assembly comprising:
a plurality of panels, each panel including an upper edge, a lower edge, and first and second side edges extending between the upper and lower edges; and
at least one tab extending outward from each of the side edges of each panel, wherein the tab is configured for removably coupling to the at least one tab extending from an adjacent panel.

10. The stake rack assembly of claim 9 wherein each of the panels is formed of a polymer material.

11. The stake rack assembly of claim 9 wherein each panel includes a support beam formed of a metal material to increase the strength of the panel.

12. The stake rack assembly of claim 9 wherein each panel includes a plurality of openings to define generally horizontal sections and generally vertical sections that define rails and stakes of the panel.

13. The stake rack assembly of claim 9 wherein the first side edge of each of the panels includes the at least one tab positioned proximate the upper edge and extending outwardly from a first surface of the panel, such that remaining tabs of the first side edge alternate between proximate a second surface opposite the first surface and the first surface.

14. The stake rack assembly of claim 13 wherein the second side edge of each of the panels includes the at least one tab positioned proximate the upper edge and extending outwardly from the second surface of the panel, such that remaining tabs of the second side edge alternate between proximate the first surface and the second surface.

15. A panel for a stake rack assembly for a cargo area of a truck bed, the panel comprising:
an upper edge, a lower edge, and first and second side edges extending between the upper and lower edges; and
a hinge extending from one of the side edges,
wherein the panel is formed of a polymer material.

16. The panel of claim 15, and further comprising a support beam movably coupled to the panel.

17. The panel of claim 16, and further comprising a handle configured for moving the support beam between a first position for coupling the panel to the truck bed and a second position.

18. The panel of claim 17 wherein the hinge includes a first and second hinge portion.

19. The panel of claim 17, and further comprising a post for pivotally coupling to the hinge of the panel, wherein the post is configured for coupling to the truck bed.

20. The panel of claim 19, and further comprising a pin for passing through the hinge and pivotally coupling the post to the panel.

21. The panel of claim 19 wherein the hinge includes a bushing for pivotally coupling the post to the panel.

22. A stake rack assembly for a cargo area of a truck bed, the stake rack assembly comprising:
a plurality of panels, each panel including first and second side edges;
at least one tab extending outward from the side edges of a first set of the plurality of panels such that the tab extending from each side edge of a first set of the plurality of panels is configured for removably coupling to the at least one tab extending from an adjacent panel of the first set; and
a hinge extending from one of the side edges of a second set of the plurality of panels,
wherein each of the plurality of panels is formed of a polymer material.

23. The stake rack assembly of claim 23, and further comprising a post for pivotally coupling at least one of the second set of the plurality of panels to the truck bed.

24. The stake rack assembly of claim 24 wherein the hinge of one panel is coupled to the post and positioned proximate the at least one tab of an adjacent panel.
